(19) United States
(12) Patent Application Publication
(10) Pub. No.: US 2006/0190978 A1
(43) Pub. Date: Aug. 24, 2006

(54) Remotely accessing a set-top terminal

(76) Inventors: Samuel H. Russ, Alpharetta, GA (US); Earl E. Turner SR., Lawrenceville, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 11/061,004

(22) Filed: Feb. 18, 2005

(51) Int. Cl. H04N 7/173

(52) U.S. Cl. 725/110; 725/109; 725/112; 725/113; 725/129

(57) ABSTRACT

An Internet server is operatively coupled to a configurable set-top terminal (STT), thereby providing remote access to the configurable STT through the Internet server. The Internet server is configured to provide web-pages that preferably emulate the user interface for the configurable STT. In that regard, a subscriber can log into the Internet server and configure the configurable STT from various devices that are Internet-compatible. The Internet server is configured to translate input by the subscriber into configuration information for the configurable STT that is pushed out to the configurable STT directly after being received from the subscriber.

### FIELD OF THE DISCLOSURE

The present disclosure relates generally to communications and, more particularly, to Internet-based communications.

### BACKGROUND

Set-top terminals (STT, or set-top boxes) provide, among other things, television programs to subscribers of cable television or satellite television, among others. Often, the STT includes configurable components that permit subscribers to set specific dates and times to record desired television programs. Typically, the dates and times for recording are configured through a user interface at either a front panel or a handheld remote control. In that regard, those systems often require a subscriber to be within close proximity to (co-located with) the STT to configure the STT.

Recently, vendors have furnished approaches in which subscribers can remotely configure their STT. However, these existing methods have various drawbacks. In view of these drawbacks, a need exists in the industry.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram showing an open network coupled with a cable television environment having a configurable set-top terminal (STT) coupled to a hard drive.

FIG. 2 is a block diagram showing various components within the hard drive of FIG.1.

FIG. 3 is a block diagram showing components of the configurable STT of FIG. 1 in greater detail.

FIG. 4 is a block diagram showing an embodiment of an environment in which a configurable STT can be remotely configured.

FIG. 5 is a block diagram showing various components of the web server of FIG. 4.

FIG. 6 is a flowchart showing an embodiment of a process performed by the local operator of FIG. 4.

FIGS. 7 through 13 show data flow diagrams in an embodiment of a process for server-mediated configuring of a configurable STT.

### DETAILED DESCRIPTION

Reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

As is known in the art, some set-top terminals (STT) permit recording of media streams (e.g., television programs) that are transmitted from, for example, a cable television headend to a broadcast television subscriber's STT, e.g., an STT authorized to at least receive broadcast television signals in accordance with a service subscription. In the event that an STT is configurable, the configurable STT permits a subscriber to configure the configurable STT to record incoming media streams (e.g., television programs) at different dates and times. In other words, such configurable STTs provide mechanisms by which a subscriber can select a particular date, time, and channel for future recording. In more sophisticated models, the dates and times can be configured as a recurring event, such as, for example, recording a television program that is broadcast every Monday evening at 8:00 p.m. Typically, the configuring of known STTs is accomplished through a interactive approach, in which a subscriber locally enters the various date, time, and channel information through a handheld remote control or a front-panel interface. Once configured, the configurable STT executes the configured function according to the subscriber's instructions. Since such configurable STTs are known in the art, further discussion of those configurable STTs is omitted here.

In accordance with one embodiment, among others, of the present disclosure, an Internet server is preferably located at a headend and is thus operatively coupled to a configurable STT, thereby providing remote access to the configurable STT through the Internet server. Other embodiments include the Internet server located at other locations remote from the STT, among other locations. The Internet server is configured to provide web-pages that emulate the user interface for the configurable STT. In that regard, a subscriber can log into the Internet server and configure the configurable STT from any device that is Internet-compatible. Preferably, the server “pushes” configuration information to the STT, e.g., the information is communicated to the STT directly after configuration changes are requested by a remotely located user through the web pages. In some embodiments, such configuration information is communicated to the STT through an in-band communication mechanism, while other embodiments utilize out-of-band communication mechanisms. For example, communication mechanisms include, among others, a dedicated QAM (quadrature amplitude modulate) channel, an MPEG (Moving Picture Experts Group) data channel, and QPSK (quadrature phase shift keying) signaling. A data carousel may also be utilized to pass such configuration information to an STT. Thus, among others, communication mechanisms may be used that are similar to mechanisms used to transfer television broadcast subscription information or confirmation information.

The Internet server is also configured to translate responses by the subscriber into instructions that the configurable STT can execute or utilize. Typically, configurable STTs operate with software that permits the subscriber to configure the configurable STT. That software permits the configurable components of the STT to pass events, which are responsible for recording and playing media streams, and maintain various lists (e.g., list of programs to be recorded, list of recorded programs, etc.). Those instructions can be translated into an Internet-compatible language, such as, for example, Hypertext Markup Language (HTML) or Extensible Markup Language (XML).

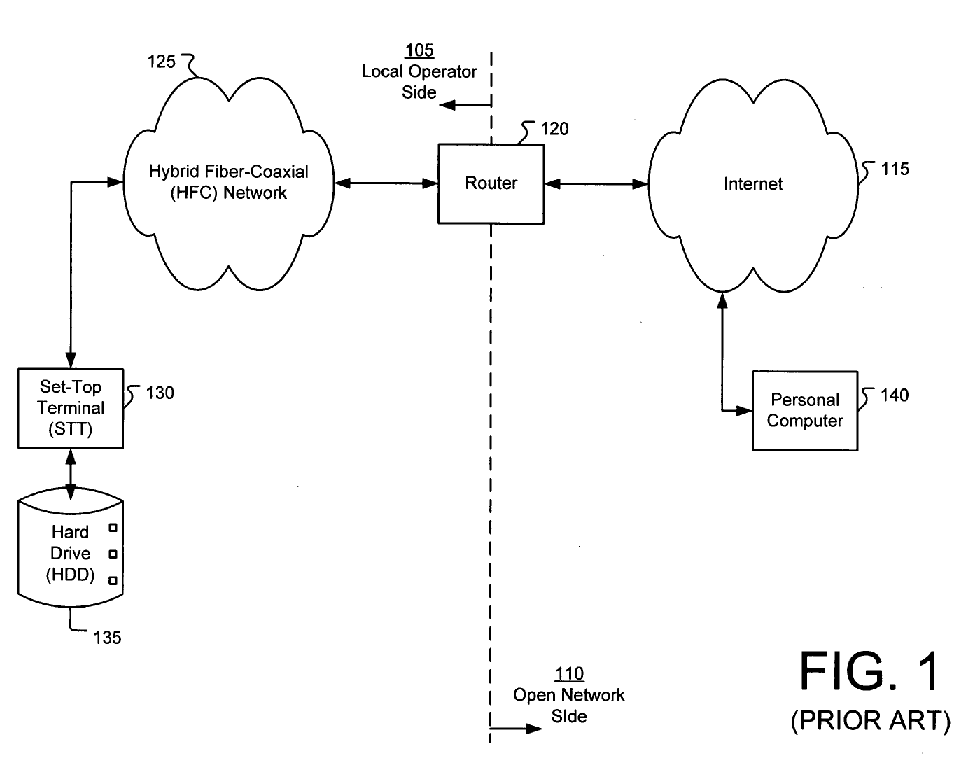

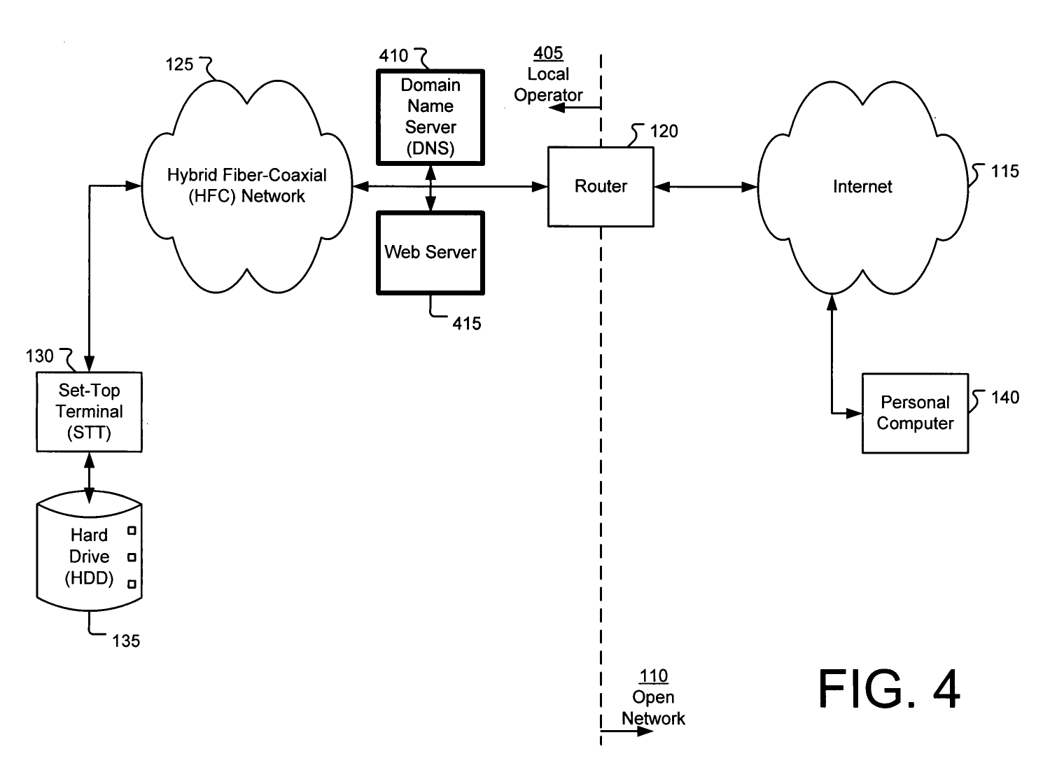

FIGS. 1 through 3 illustrate existing architectures for both an open network 110, such as the Internet, and a cable television network, which includes various components associated with a local cable operator 105. FIGS. 4 through 13 provide various embodiments of systems and methods for remotely accessing and configuring a subscriber's configurable STT.

FIG. 1 is a block diagram showing an open network 115 coupled with a cable television environment 105 having a configurable set-top terminal (STT) 130 coupled to a hard drive 135. As shown in FIG. 1, the open network is shown as the Internet 115. As is known, various computing devices, such as personal computer (PC) 140, can be communicatively coupled to the Internet 115, thereby permitting the PC 140 to communicate with other devices (not shown) that may be communicatively coupled to the Internet 115.

The cable television environment of FIG. 1 is communicatively coupled to the open network side 110 through a router 120. As is known, a hybrid fiber-coaxial (HFC) network 125 is present in the local operator side 105 of the cable television environment. A set-top terminal (STT) 130 is communicatively coupled to the HFC network 125. A hard drive (HDD) 135, on which various recorded programs (among other things) are stored, is typically co-located with the STT 130. Often, the HDD 135 is located within the STT 130 itself. While a television or display device (not shown) can be connected to an STT 130, the elements of STT 130 can also be located within a television or display device in some embodiments.

For other embodiments, it should be appreciated that the STT 130 can be connected via a satellite headend, or connected over an in-home local area network (LAN) to an Internet service provider (ISP). In yet other embodiments, the STT 130 can be connected over a digital subscriber line (DSL) connection and have a TELCO modem to facilitate data transfer.

Since HFC networks 125, open networks 110, the conventional configurable STT 130, and the various components related to FIG. 1 are known in the art, no further description of the environment of FIG. 1 is provided herein.

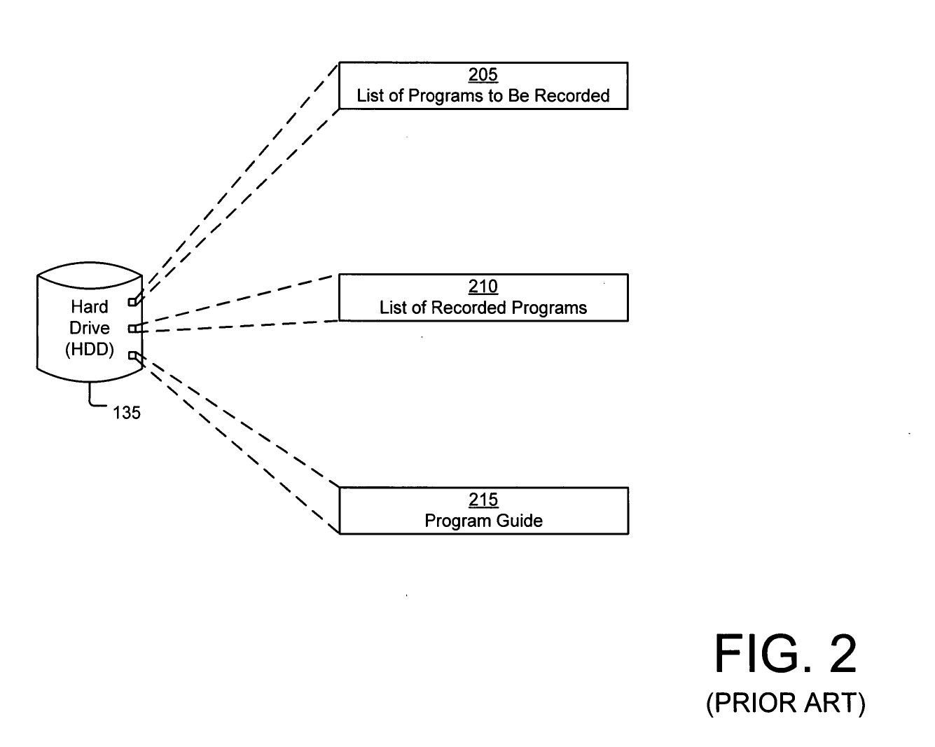

FIG. 2 is a block diagram showing various components within the hard drive 135 of FIG. 1. As shown in FIG. 2, the hard drive 135 stores various components that are associated with the STT 130. For example, the components may include a list of programs to be recorded 205, a list of recorded programs 210, and a program guide 215. The lists 205, 210 and the program guide 215 permit a user to store various configuration parameters for the STT 130. Since each of these components is known in the art, further discussion of the components of FIG. 2 is omitted here.

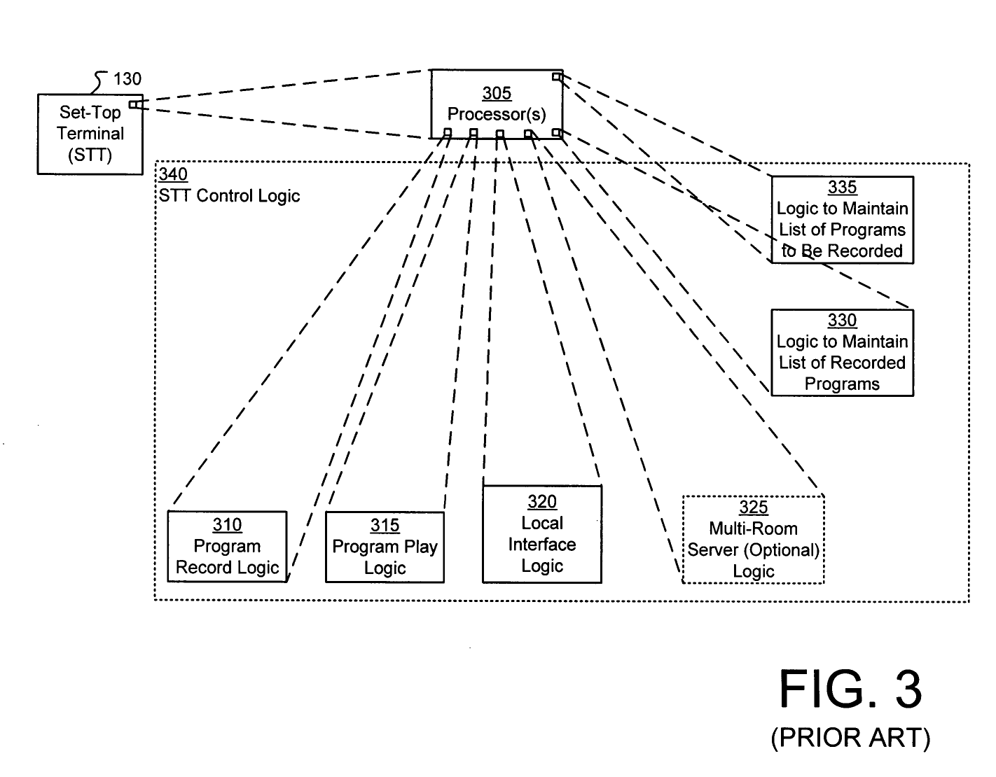

FIG. 3 is a block diagram showing components of the configurable STT of FIG. 1 in greater detail. Given the lists 205, 210 and the program guide 215 of FIG. 2, a user at the STT 130 can establish various configuration parameters for immediate or future execution. For example, using a user interface that is displayed for the user, for example, on a television (TV) that is connected to the STT 130, the user can configure the STT 130 to record future programs (also referred to herein as “media streams”). Similarly, the user can maintain recorded programs by, for example, deleting the program or accessing the program for play. Since the STT 130 is configurable, the STT 130 includes a processor 305 with various STT control logic 340.

The STT control logic 340 includes, for example, program record logic 310 that controls the recording of various programs by the STT 130. Similarly, the STT control logic 340 includes program play logic 315 that controls the playing of various programs that may be stored on the configurable STT 130. The STT control logic 340 also includes local interface logic 320, which renders a graphical user interface on, for example, a TV for the user to configure the STT 130.

In addition to the play and record logic 310, 315, the STT control logic 340 includes logic 330 to maintain a list of recorded programs and logic 335 to maintain a list of programs to be recorded. The logic 330 to maintain a list of recorded programs is configured to maintain a list of all programs that are recorded on the hard drive 135. For example, if there are already five movies recorded on the hard drive 135, then the logic 330 to maintain the list of recorded programs permits a user to track the five recorded movies in accordance with known methods. Likewise, the logic 335 to maintain a list of programs to be recorded permits a user to maintain and track programs (e.g., movies, TV shows, etc.) that the user wishes to record in the future. Since such logic components are known in the art, further discussion of these logic components is omitted here.

While the components of FIGS. 1 through 3 provide a convenient approach to playing and recording programs from an STT 130, the environment of FIGS. 1 through 3 often require a user to be in close proximity to the STT 130, since these STTs are typically configurable using a front-panel interface or a handheld remote control. Some systems, such as U.S. Patent Application Serial Number 2003/0005446 by Jaff et al., published on Jan. 2, 2003, permit a user to directly access an STT over the Internet. The direct access to the STT provides remote configuring capabilities. However, one drawback behind the Jaff system is that each STT would require a unique IP address, and a user system would need a priori knowledge of the IP address in order to perform the remote configuring (programming) of the STT.

The embodiments disclosed below provide server-mediated remote access to the STT. Such server-mediated access permits the server-side (e.g., the service provider) greater flexibility in controlling access to user STTs. Additionally, the server-mediated access permits the server-side to provide easier access to the STT by, for example, providing Uniform resource locators (URLs) as a selectable hypertext markup language (HTML)-link the STT. Also, the server can provide a list of publicly accessible URLs. For all of these embodiments, a user system need not have a priori knowledge of an STT IP address. Additionally, since the login to the STT is server-mediated, the login access can be simplified by making much of the access steps transparent to the end-user. For example, the system can be configured such that the end user can log in with a single host name, such as, for example, one provided at a fixed domain name. From there, the server can direct the user to the proper STT using, for example, a login name and a password. For other embodiments, the server can require such authentication prior to displaying lists of URLs.

Also, since the server mediates the transaction between the end user and the STT, once that transaction is completed, the server need not continually maintain individual STT information. Rather, that information can be removed from the server, once the end user has finished accessing the STT. Furthermore, since the server can also have a copy of its own program guide, the STT, which also has a copy of the program guide, need not upload that information to the server. Since high bandwidth information, such as the program guide, does not occupy the network traffic between the STT and the server, there will likely be less network congestion between the STT and the server.

These and other advantages will become apparent to those having skill in the art upon reading the following description of various embodiments of systems and methods for near-real-time server-mediated remote access of a configurable STT by a user.

FIG. 4 is a block diagram showing an embodiment of an environment in which a configurable STT can be remotely configured. Similar to FIG. 1, the environment of FIG. 4 shows an open network 115 coupled with a cable television local operator 405. the local operator side 405 includes a configurable STT 130 coupled to a hard drive 135. As shown in FIG. 4, the open network is shown as the Internet 115. As is known, various computing devices, such as a PC 140, can be communicatively coupled to the Internet 115, thereby permitting the PC 140 to communicate with other devices (not shown) that may be communicatively coupled to the Internet 115.

The cable television environment of FIG. 4 is communicatively coupled to the open network side 110 through a router 120. As is known, a hybrid fiber-coaxial (HFC) network 125 is present in the local operator side 405 of the cable television environment. The STT 130 is communicatively coupled to the HFC network 125 in near-real-time (commonly referred to as “real time”). The STT 130 is also coupled to the hard drive (HDD) 135. Various recorded programs (media streams), among other things, are stored on the HDD 135, which may be attached to the STT 130 or located within the STT 130.

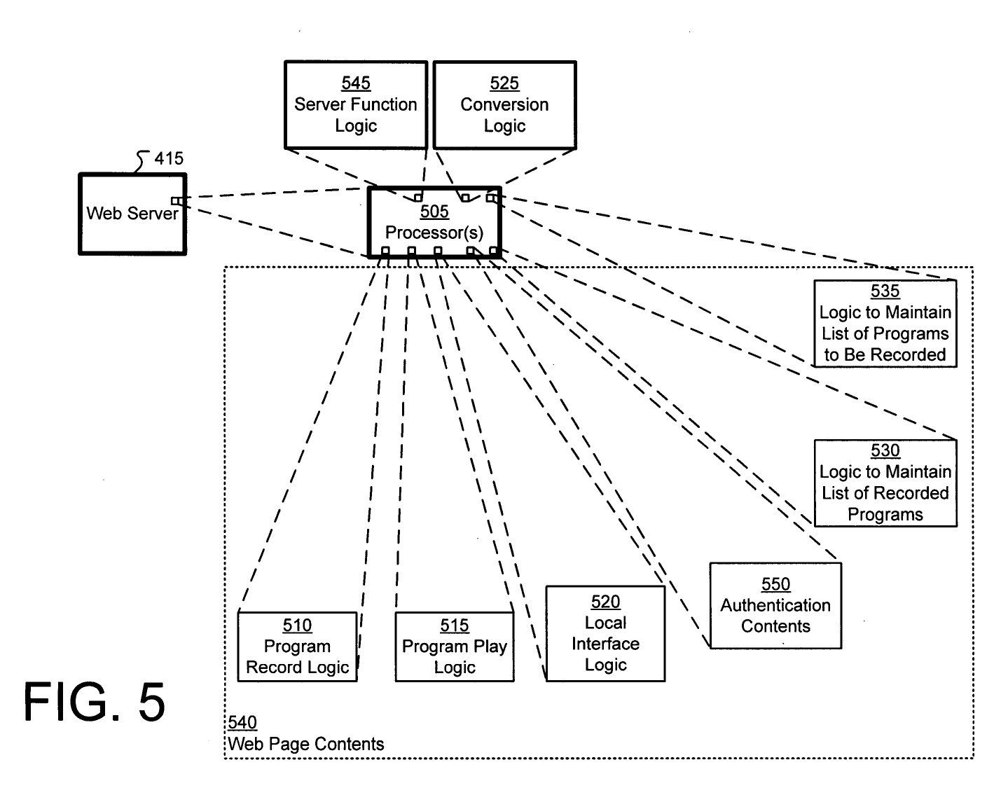

Unlike the environment of FIG. 1, the environment of FIG. 4 further includes a domain name server (DNS) 410 and a web server 415. The DNS 410 maintains a database of IP addresses for all of the STTs that are connected to the HFC network 125. Thus, when a user requests access to a particular STT, the DNS 410 identifies the corresponding IP address associated with the particular STT. Thus, should the IP address of a particular STT change over the course of time, the DNS 410 provides a mechanism by which an end user can access the STT, despite a potentially-changing IP address. Having a server-mediated approach facilitates proper tracking of STT IP addresses, which may not be possible in systems that are similar to that of Jaff et al. The web server 415 provides server-side components, which permit access by a user to various STTs on the local operator side 405 of FIG. 4. Since the STT 130 is “logged in” real time to the HFC network 125 on the local operator side 405, this permits near-real-time configuring of the STT 130 from a remote device that has access to the HFC network 125. The components of the web server 415 are shown in greater detail in FIG. 5.

FIG. 5 is a block diagram showing various components of the web server 415 of FIG. 4. As shown in FIG. 5, the web server 415 includes a processor 505, which performs various functions that permit server-mediated access of STTs by end users. As such, the processor 505 includes web page contents 540, which are comparable to the functions provided at a local user interface for an STT. In one example, among others, the web page contents 540 may include local interface logic 520, which emulates a graphical user interface that is provided to the user from an STT so that the user can configure the STT. Additionally, the web page contents 540 may include program record logic 510 and program play logic 515, which permit a user to respectively record and play programs on the STT. The web-page contents 540 may also include authentication contents 550, which provide contents for authenticating a user's access to a particular STT. The web page contents 540 further provide logic 535 to maintain a list of programs to be recorded and logic 530 to maintain a list of recorded programs. As described in greater detail below, these web page contents 540 are provided by the web server 415 to a user at a client machine, thereby permitting the client machine to emulate the user interface of the STT from a remote location.

The processor 505 also includes server function logic 545, which performs various server functions that permit the client machine (not shown in FIG. 5) to access the web page contents 540. Also, since the web server 415 also interfaces with the STT, the processor 505 further includes conversion logic 525, which is configured to convert web-based commands into control commands that are recognized by the STT. Likewise, the conversion logic 525 is configured to convert control commands and other information from the STT into a format that can be easily rendered by a web browser on a client machine. Since these, and other, server functions are described in greater detail below, no further discussion of these components is provided with reference to FIG. 5.

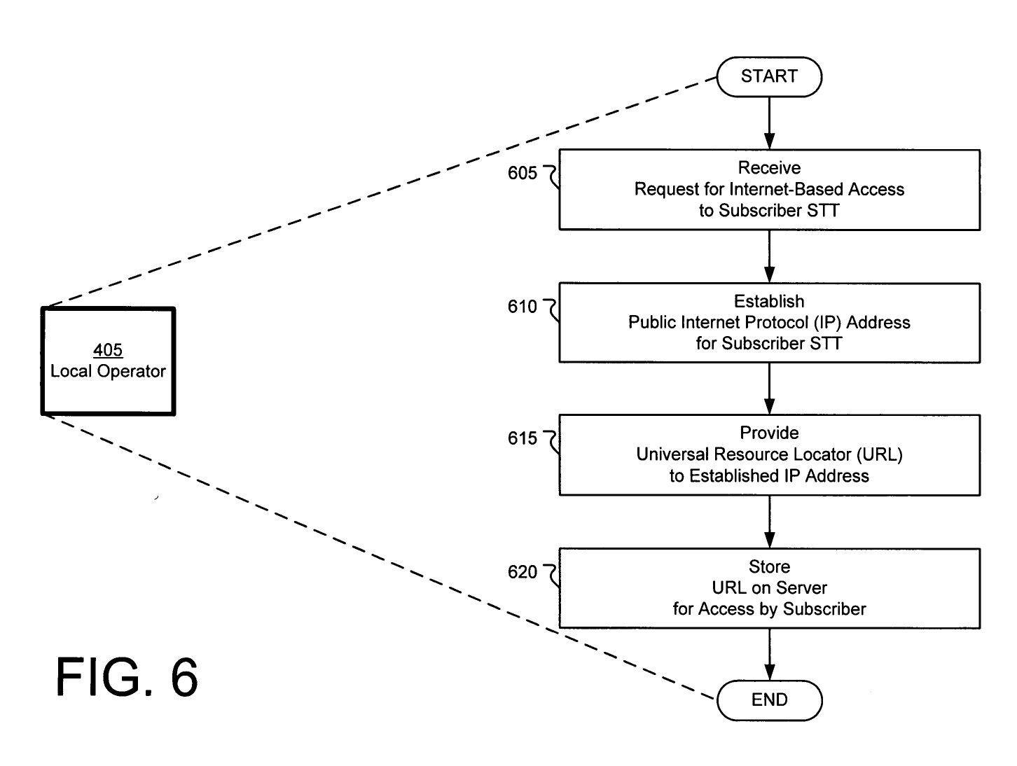

FIG. 6 is a flowchart showing an embodiment of a process performed by the local operator 405 of FIG. 4. For some embodiments, the process of FIG. 6 occurs when a local operator 405 provides access to a subscriber's (or end user's) STT through an Internet server. Thus, for example, the process of FIG. 6 may occur when a subscriber seeks to have access to the subscriber's STT over the Internet.

In such a scenario, when the subscriber conveys that request to the local operator 405, the local operator 405 receives (605) that request for Internet-based access to the subscriber's STT. Upon receiving (605) that request, the local operator 405 establishes (610) an IP address for the subscriber's STT, and also provides (615) a URL to that IP address. That URL is stored (620) on the server for access by the subscriber. In that regard, when a subscriber subsequently accesses the server through a client machine, the server provides the subscriber with the URL, which then provides Internet-based access to the subscriber's STT. Hence, the subscriber is provided with server-mediated access to the subscriber's STT.

For some embodiments, the URL is displayed on a local STT for a subscriber, so that the subscriber can write down or otherwise save the URL for future use. For other embodiments, rather than providing a URL, other types of hyper-text transfer protocol (HTTP)-formatted Internet addresses can be provided. For example, such an address can be dynamically provided in an Active Server Page (ASP) or other similar dynamic URL schemes, which are known in the art. In other embodiments, no URL or address is provided to a user as part of a web page, and in some embodiments, any URL shown in an address area of a browser is dynamically generated and can change from viewing to viewing. Furthermore, a URL may reference dynamically generated information or a static web page with links to dynamic information. In addition, some embodiments do not require the user to remember or save a URL that is specific to that user. Instead, the user may simply input identifying (authentication) information, such as a username and/or password, after which the user is automatically provided a web page interface to that user's STT.

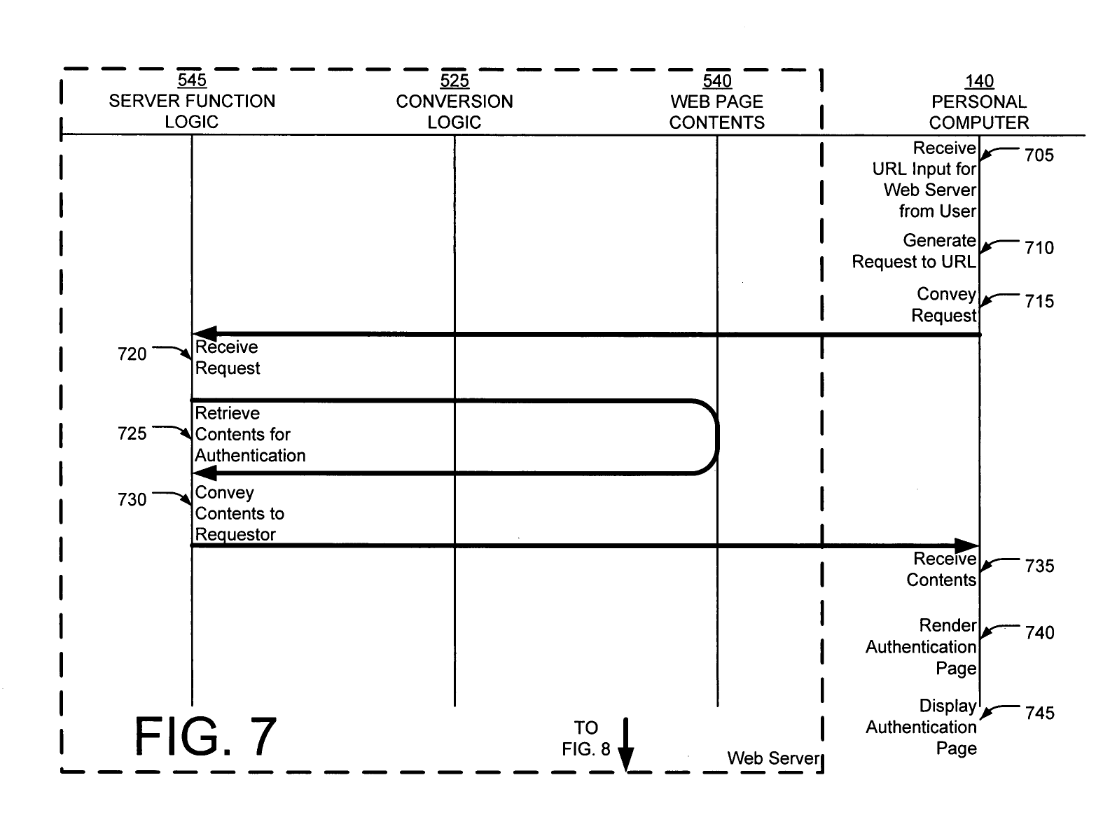

FIGS. 7 through 13 show data flow diagrams in an embodiment, among others, of a process for server-mediated configuring of a configurable STT. For some embodiments, the processes of FIGS. 7 through 13 occur after the Internet-based access has been established by the local operator 405, as shown in FIG. 6.

As shown in FIG. 7, the process begins when a subscriber (or user) at a personal computer 140 provides the URL for the web server 415 at a web browser on the personal computer 140 (or any other client machine, such as, for example, a personal digital assistant (PDA), cellular telephone, etc.). The user can provide the URL by directly inputting the URL into a web browser. Alternatively, if the user has saved the URL in a “favorites” folder (or equivalent folder), then the user can provide the URL by selecting the previously-saved URL from the folder. The PC 140 receives (705) the URL, which has been provided by the user, and generates (710) a request, which is conveyed (715) from the PC 140 to the web server 415 in accordance with known methods.

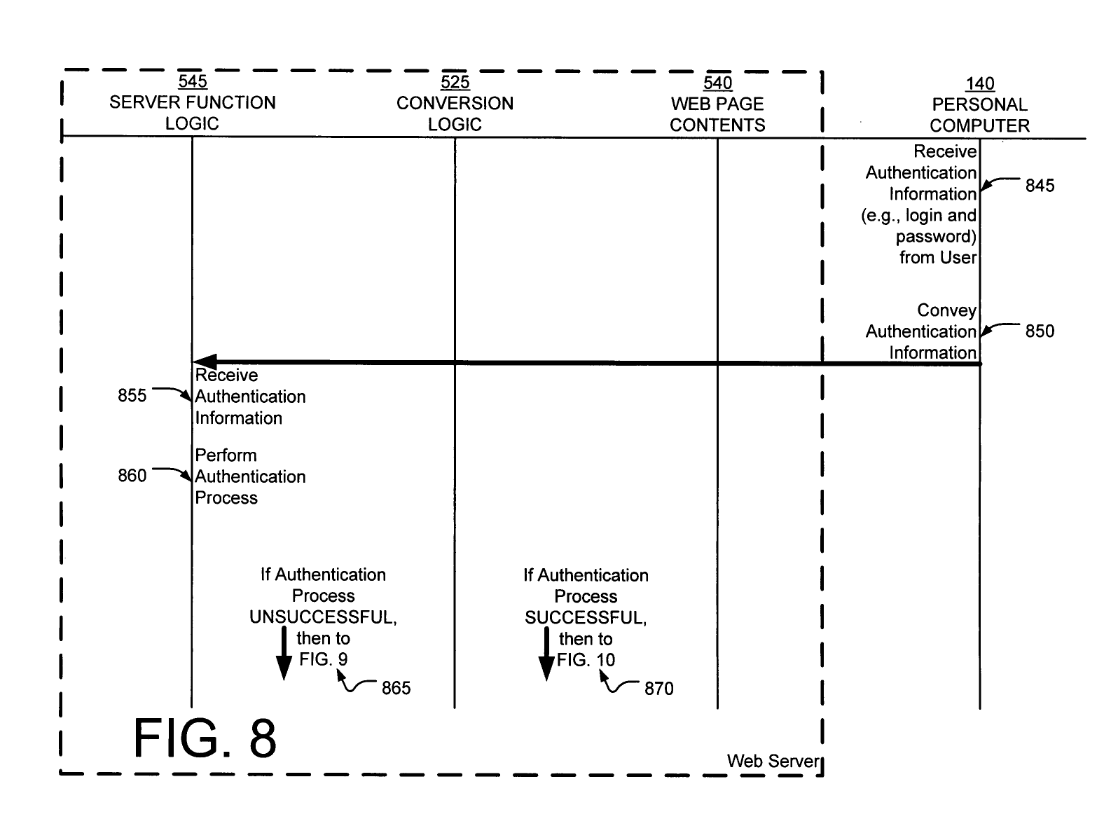

The server function logic 545 at the web server 415 receives (720) the request and subsequently retrieves (725) contents for authentication from the web page contents 540. Those contents are then conveyed (730) to the requesting PC 140 in accordance with known Internet protocols. The PC 140 receives (735) the contents and then renders (740) an authentication page using those contents. That authentication page is then displayed (745) to the subscriber (or user) at the PC 140. The process continues to FIG. 8.

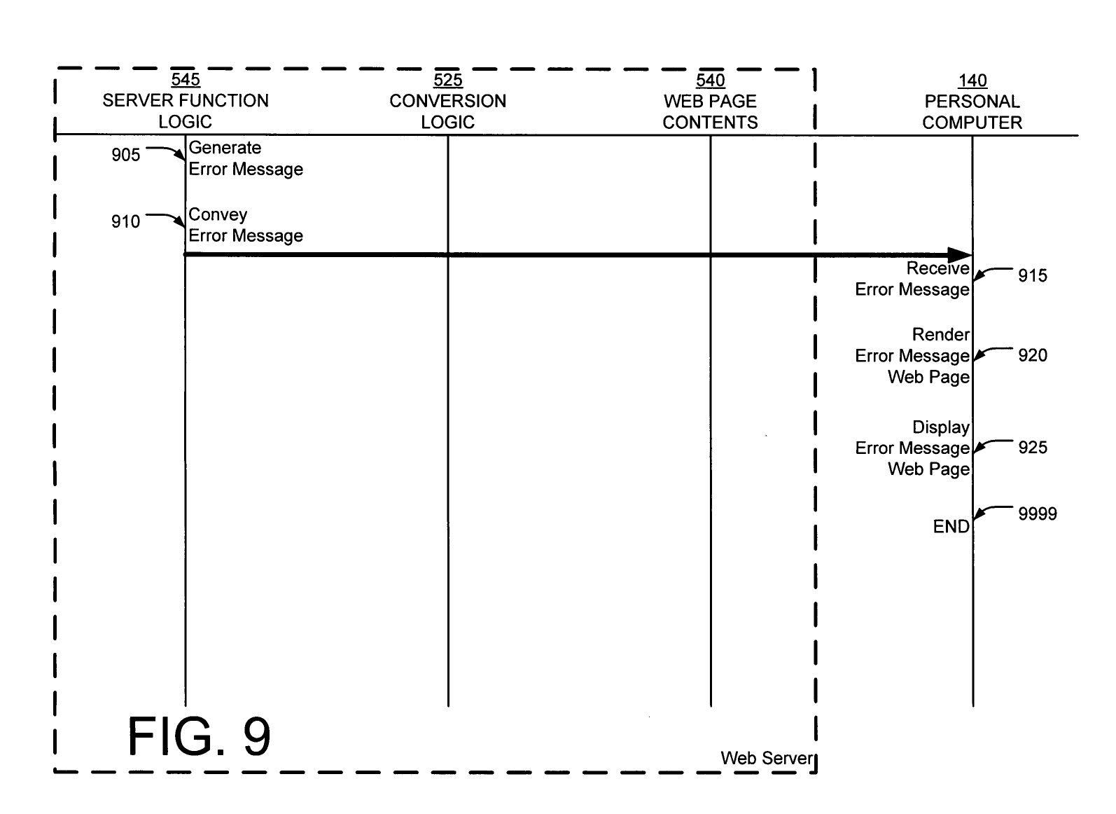

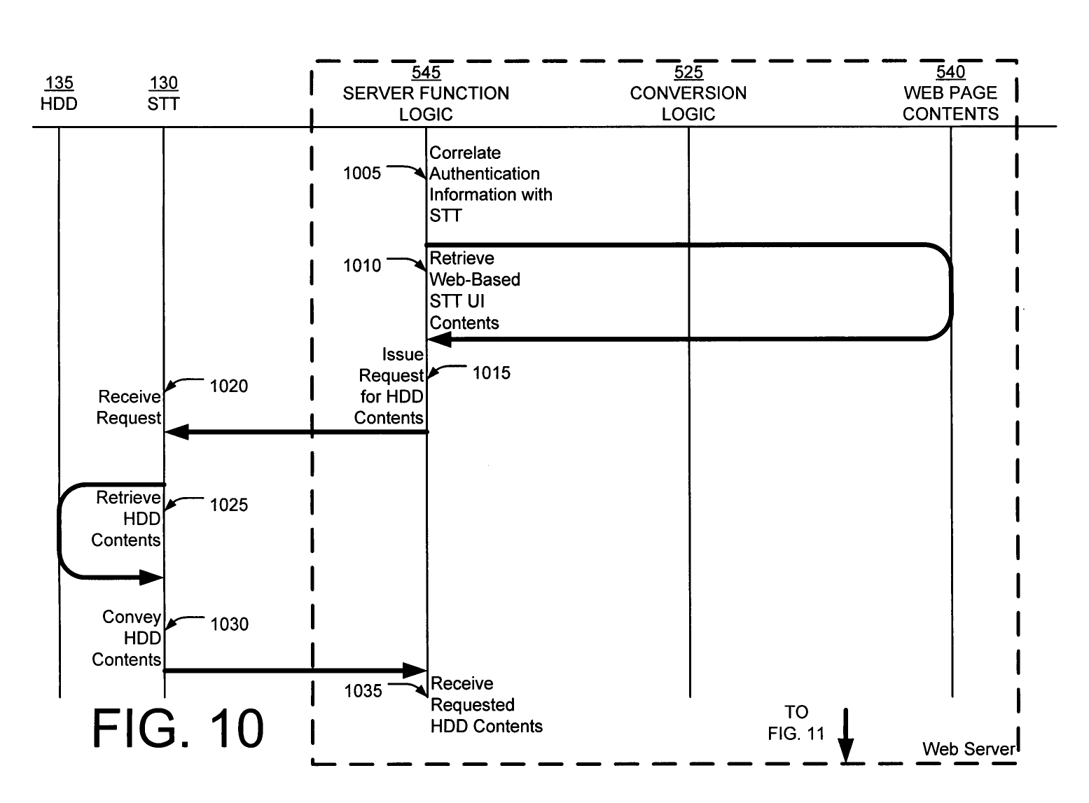

For some embodiments, the authentication page may request a login name and password, or other verification information. Once the PC 140 receives (845) this information from the subscriber, the PC 140 conveys (850) the authentication information back to the web server 415. For other embodiments, the login name and password may be saved on the PC 140, thereby permitting an automated login response by the PC 140 without additional user intervention. For yet other embodiments, the login name and password may be saved in a file for easy access by the user. The server function logic 545 at the web server 415 receives (855) the authentication information and performs (860) an authentication process using one or more known authentication processes. If the authentication process is unsuccessful, then the process continues (865) to FIG. 9. Conversely, if the authentication process is successful, then the process continues (870) to FIG. 10.

As shown in FIG. 9, if the authentication process is unsuccessful, then the server function logic 545 generates (905) an error message, which is conveyed (910) to the PC 140. The PC 140 receives (915) the error message and renders (920) an error message page for display (925) on the PC 140. The process then ends (9999).

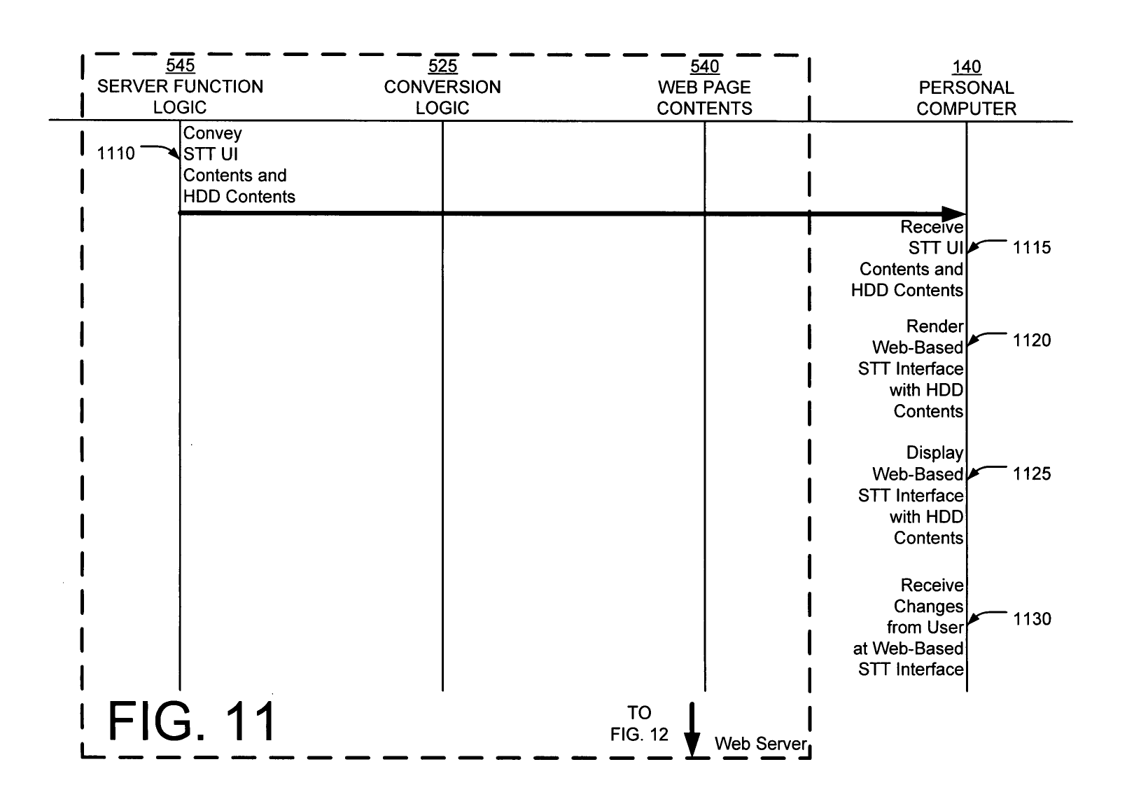

As shown in FIG. 10, if the authentication process is successful, then the server function logic 545 correlates (1005) the authentication information with a corresponding STT. The server function logic 545 also retrieves (1010) web-based STT user interface (UI) contents from the web-page contents 540 on the web server 415. Having correlated the authentication information with a corresponding STT, the server function logic 545 issues (1015) a request for the HDD contents of the corresponding STT. The appropriate STT 130 receives (1020) the request and retrieves (1025) the HDD contents from its HDD 135. Those contents are then conveyed (1030) back to the web server 415, and the server function logic 545 receives (1035) the requested HDD contents. The process then continues to FIG. 11.

Upon receiving the HDD contents from the STT 130, the server function logic 545, as shown in FIG. 11, conveys (1110) the STT UI and the HDD contents to the PC 140. Those contents are received (1115) by the PC 140, which then renders (1120) and displays (1125) a web-based STT UI, which includes the recently-retrieved HDD contents.

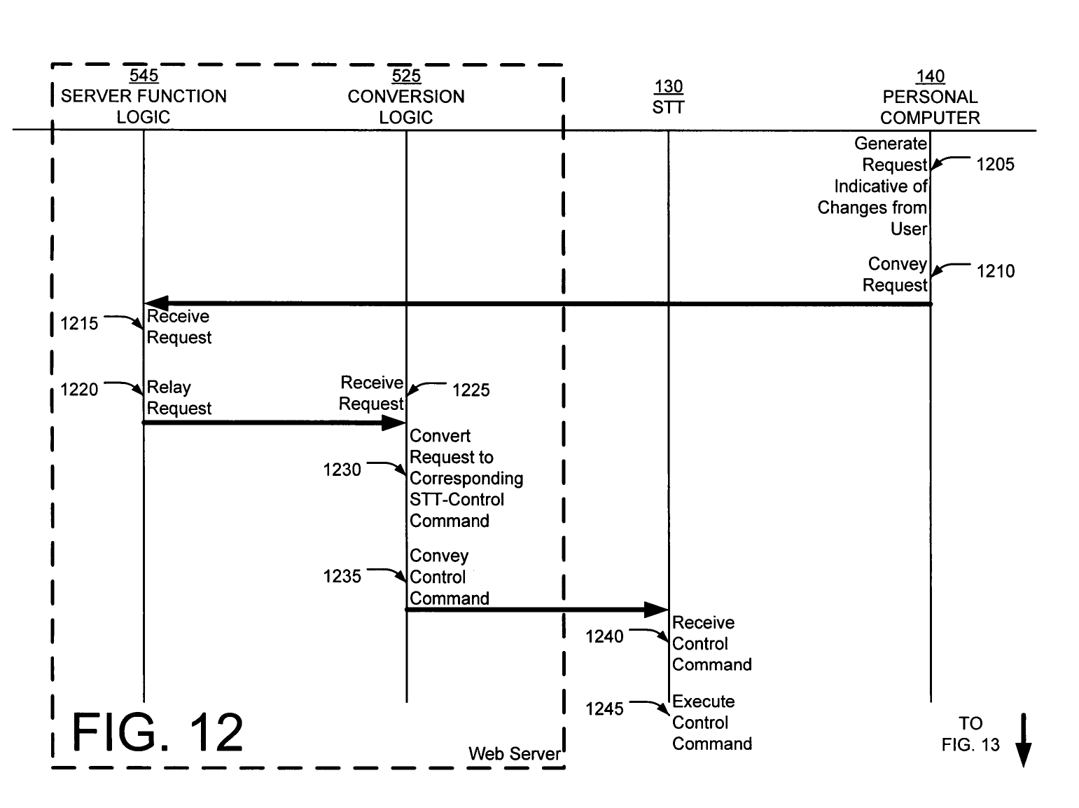

From the displayed STT UI, the subscriber (or user) can make modifications to existing programs (e.g., delete already recorded programs) or make modifications to future programs (e.g., set times and dates for new recordings). Once the user enters those changes, the PC 140 receives (1130) those changes at the web-based STT UI, and the process continues to FIG. 12.

In the embodiment of FIG. 12, upon receiving (1130) the changes from the user, the PC 140 generates (1205) an Internet-compatible request, which is reflective of those changes from the user, in accordance with known Internet protocols. The generated request is then conveyed (1210) from the PC 140 to the web server 415. The server function logic 545 at the web server 415 receives (1215) the request and relays (1220) the request to the conversion logic 525. The conversion logic 525 receives (1225) the request and converts (1230) the request into a corresponding STT control command. For example, if the request is reflective of a “play” command, then the conversion logic 525 converts the Internet-based command into a “play” command that will be recognized by the STT 130. That STT control command is then conveyed (1235) from the web server 415 to the STT 130. The STT 130 receives (1240) the control command and executes (1245) the command as if it had been entered from a handheld remote control or a front panel of the STT 130.

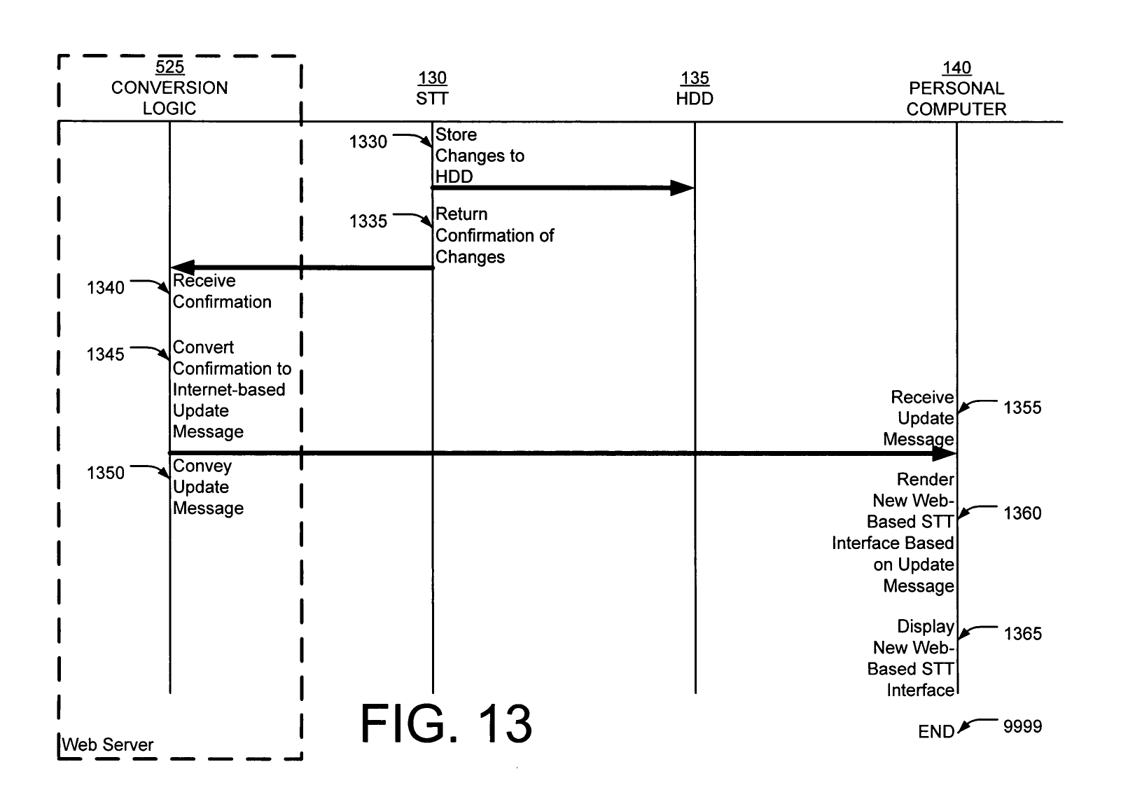

Since the conversion of the web-based command to the STT control command is performed at the web server 415, the existing hardware on the STT 130 need not be modified, thereby providing a relatively transparent process for the subscriber. Upon executing the control command, the process continues to FIG. 13.

As shown in FIG. 13, the STT 130 stores (1330) any changes to its configuration to its hard drive 135. Additionally, the STT 130 returns (1335) a confirmation of the changes to the web server 415. As is known, the confirmation can be passed from the STT 130 to the web server 415 using known event notification and other protocols.

The web server 415 receives (1340) the confirmation, and the conversion logic 525 at the web server 415 converts (1345) the confirmation into an update message for transmission over the Internet. That update message is then conveyed (1350) from the web server 415 to the PC 140. The PC 140 receives (1355) the update message and renders (1360) a new web-based STT UI based on the update message. This new web-based STT UI is then displayed (1365) to the subscriber or user, and the process ends (9999). Thus, for example, if the configuration on the STT 130 has been modified, then the new STT UI, which is displayed to the subscriber, reflects the modified configuration at the STT 130.

As shown in the embodiments of FIGS. 7 through 13, by providing near-real-time access to an STT over the Internet through a web server, a user can remotely configure the STT without the need to be physically present at the STT. Additionally, should the handheld remote control or the front panel malfunction or be inoperable, such a mechanism permits an alternative approach to configuring an STT.

The processes in the processor, such as, for example, the server function logic 545, the conversion logic 525, the program record logic 510, the program play logic 515, the local interface logic 520, the logic to maintain the list of recorded programs 530, and the logic to maintain the list of programs to be recorded 535, may be implemented in hardware, software, firmware, or a combination thereof. In the preferred embodiment(s), these processes are implemented in software or firmware that is stored in a memory and that is executed by a suitable instruction execution system. If implemented in hardware, as in an alternative embodiment, the processes can be implemented with any or a combination of the following technologies, which are all well known in the art: a discrete logic circuit(s) having logic gates for implementing logic functions upon data signals, an application specific integrated circuit (ASIC) having appropriate combinational logic gates, a configurable gate array(s) (PGA), a field configurable gate array (FPGA), etc.

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

Although exemplary embodiments have been shown and described, it will be clear to those of ordinary skill in the art that a number of changes, modifications, or alterations to the disclosure as described may be made. For example, the exchange of HDD contents between the web server 415 and the STT 130, as shown in FIG. 10, may be performed using compressed data, thereby reducing network traffic. Additionally, for security reasons, the data transfer between the web server 415 and the STT may be encrypted using, for example, a proprietary encryption algorithm or a publicly available encryption algorithm. Similarly, the data exchange between the web server 415 and the PC 130 (or other client device) can be compressed and/or encrypted using, for example, SSL or other public encryption algorithms.

Also, for other embodiments, it should be appreciated that the server can be updated with information when a subscriber updates a list of recorded programs (or a list of programs to be recorded, etc.) directly from the subscriber's STT. For such embodiments, the server would store the lists of programs for each subscriber at the server. In that regard, for such embodiments, each subscriber's lists of programs would be stored at the server and updated periodically, or updated when a subscriber directly programs the STT using a handheld remote control or a STT front panel. Timing of updating could also be managed for any bandwidth control concerns, as well as providing a slight delay to help ensure that all changes for a while from a user have been received at the STT. Furthermore, storage of such information at a server could be limited to particular users, such as, for example, those users who have indicated an interest in such a service, such as by attempting to access their associated STT remotely. In such embodiments, the process beginning at step 1015 in FIG. 10, in which the STT is queried for information, can be avoided in some, or all, situations.

For yet other embodiments, the list of recorded programs and the list of programs to be recorded can be uploaded from the STT to the server periodically for all users. Thus, for those embodiments, when a user logs in, the server can readily provide the user's lists without the additional need to access the STT.

All such changes, modifications, and alterations should therefore be seen as within the scope of the disclosure.

What is claimed is:

1. A system comprising:
logic configured to receive a request from a remote client through a web interface;
logic configured to convert the request into instructions for a set-top terminal; and
logic configured to convey the instructions to the set-top terminal directly after converting the request into the instructions.

2. The system of claim 1, wherein the set-top terminal is a broadcast television subscriber terminal with storage for recording broadcast television programs.

3. The system of claim 1, wherein the logic to receive the request from a remote client through a web interface is included within a web server locately remotely from the remote client and remotely from the set-top terminal.

4. The system of claim 3, wherein the web server is located in a cable headend.

5. The system of claim 3, wherein the web server is located in a satellite headend.

6. The system of claim 1, wherein the web interface includes a list of programs previously identified by the subscriber while located at the set-top terminal.

7. The system of claim 1, wherein the web interface includes a list of programs to be recorded and a list of programs already recorded.

8. The system of claim 7, further comprising logic to obtain the lists from the set-top terminal before the web interface includes the lists.

9. A method comprising the steps of:
coupling an Internet server to a set-top terminal; and
providing push configuration capabilities for the configurable set-top terminal through the Internet server.

10. The method of claim 9, wherein the set-top terminal is a broadcast television subscriber terminal with storage for recording broadcast television programs.

11. The method of claim 9, wherein the Internet server is a web server located in a cable headend.

12. The method of claim 9, wherein the Internet server is a web server located in a satellite headend.

13. The method of claim 9, wherein the step of providing push configuration capabilities comprises the steps of:
assigning an Internet Protocol (IP) address to the configurable set-top terminal;
establishing a Uniform resource locator (URL) that corresponds to the IP address; and
storing the URL for access by a subscriber.

14. The method of claim 9, wherein the step of providing push configuration capabilities includes the steps of:
storing contents that are accessible by a remote client, the contents being associated with a user interface for configuring the configurable set-top terminal;
receiving a request for the stored contents; and
conveying the stored contents in response to receiving the request.

15. The method of claim 9, wherein the step of providing push configuration capabilities comprises the steps of:
receiving a request from a remote client;
converting the request into a configuration instruction for the configurable set-top terminal; and
conveying the configuration instruction to the configurable set-top terminal directly after receiving the request.

16. The method of claim 15, wherein the step of receiving the request comprises a step selected from the group consisting of:
receiving a request to modify a list of programs to be recorded;
receiving a request to modify a list of recorded programs;
receiving a request to play a program at the configurable set-top terminal; and
receiving a request to record a program at the configurable set-top terminal.

17. The method of claim 16, wherein the step of receiving the request to modify a list of programs to be recorded comprises a step selected from the group consisting of:
receiving a request to schedule a program to be recorded; and
receiving a request to delete a program from the list of programs to be recorded.

18. The method of claim 16, wherein the step of receiving the request to modify a list of recorded programs comprises the step of receiving a request to delete a program that has already been recorded.

19. The method of claim 9, wherein the step of providing push configuration capabilities comprises the steps of:
receiving a confirmation from the configurable set-top terminal, the confirmation being indicative of a configuration change at the configurable set-top terminal;
converting the confirmation to an Internet-compatible message; and
conveying the Internet-compatible message to a remote client.

20. The method of claim 19, wherein the step of receiving the confirmation comprises a step selected from the group consisting of:
receiving an indication that a list of programs to be recorded has been modified;
receiving an indication that a list of recorded programs has been modified;
receiving an indication that a program is being played at the configurable set-top terminal; and
receiving an indication that a program is being recorded at the configurable set-top terminal.
